(19) United States
(12) Patent Application Publication
(10) Pub. No.: US 2006/0143060 A1
(43) Pub. Date: Jun. 29, 2006

(54) Integrated scheduling system for health care providers

(75) Inventors: Anne Marie Conry, Wauwatosa, WI (US); Gopal B. Avinash, New Berlin, WI (US)

Correspondence Address: Patrick S. Yoder;FLETCHER YODER, P.O. Box 692289, Houston, TX, 77269-2289, US

(73) Assignee: General Electric Company

(21) Appl. No.: 11/023,919

(22) Filed: Dec. 28, 2004

(51) Int. Cl. G06F 9/46

(52) U.S. Cl. 705/8

(57) ABSTRACT

A technique for scheduling health care resources includes identifying particular characteristics of either the resources required for a procedure to be scheduled, or characteristics of a scheduling request. The characteristics may include a particular type of resource, its capabilities, skill levels of personnel, and so forth. Characteristics of requests may include urgency levels of procedures, urgency levels of service to be performed on required equipment, and so forth. Based upon the characteristics, the needed resources are scheduled, and schedules for each of the resources may be created, updated or modified. The characteristics may serve as a basis for prioritizing either the resources, the requests, or both.

The present invention relates generally to the field of health care, and more particularly to techniques for scheduling resources, facilities, physicians, patients, and other people and components involved in providing high-quality health care in an efficient matter.

Great strides have been made in recent decades in the provision of health care. In developed economies, never before have resources been allocated to health care as they are at present. A wide range of specialties have developed, as well as supporting technologies for the tracking of health conditions, diagnosis of disease, and the treatment of patients. As such available resources and techniques have increased, however, their interdependence, complexity and scheduling become problematic.

Among the resources available for health care must be included, first and foremost, the patient. Ultimately, all health care is designed to improve the quality of life of the patient based upon health conditions, medical events, disease states, and so forth. Physicians and technicians involved in providing such health care include family practitioners, primary care physicians, specialists, surgeons, radiologists, nursing staffs, clinicians and technicians, and many other support personnel and services. All of these are key to the provision of high-quality health care.

Facilities and systems, too, are key to quality health care. Such facilities include physical plants, such as hospitals, institutions, clinics, and so forth. Within such institutions, the facilities might include anything from surgical suites to emergency rooms, patient rooms, and all of the support systems used in these facilities. Other key equipment includes medical diagnostic imaging systems, such as X-ray systems, computed tomography systems, magnetic resonance imaging systems, positron emission tomography systems, ultrasound systems, and so forth. Still further, patient monitors, data archiving and communication systems, and a myriad of other equipment is commonly drawn upon for diagnoses, treatment and, more generally, care.

Still further, various support services are often key to maintaining the facilities and equipment in good working order. Reliability is important in health care insomuch as the inability to utilize facilities and equipment in case of need may compromise the full extent to which a patient may be treated. Remote and on-site services include maintenance and repair services for the physical facilities and plant, their support systems, as well as for the highly complex equipment utilized by the health care providers. For example, medical diagnostic imaging, monitoring, treatment and other equipment are often maintained in a good working state by remotely accessing the equipment and providing remote service, where possible, and by on-site service where needed.

Scheduling all of the resources necessary for providing high-quality health care is, to say the least, a highly complex task. Conventional scheduling included simple notation of appointment times in a physician's calendar based upon available openings and patient availability. However, with the advent the increasing range of resources available, more complex scheduling is needed. Such scheduling is not only necessary between the direct health care resources, but also for services provided, including repair and maintenance services to the facilities and equipment.

As health care institutions and providers encounter increasingly constrained budgets and costs, moreover, pressures to accurately and efficiently schedule all of these resources increase. Optimal or near-optimal scheduling that increases the productivity of the health care providers, their facilities, and their equipment, and minimizes direct, indirect and service costs will be key to future health care.

### BRIEF DESCRIPTION

The present invention provides techniques designed to permit scheduling that satisfy such needs. The techniques may be applied in a range of settings, particularly for hospitals, institutions, and clinics, but also for care providers, service providers, physicians, and so forth. The techniques may also be provided, depending upon the particular business model envisioned, by scheduling services that may be fully or partially outsourced. The techniques permit information to be gathered, such as by data mining, that provides a reliable indication of times required for specific procedures and operations based upon a multitude of characteristics. Such characteristics may include aspects of the patient himself, knowledge of performance of various physicians, staff, technicians, clinicians and other care providers, knowledge of facilities and equipment, and so forth. Performance indications may also be available for service providers, including field engineers, remote service providers, and the like who are tasked with maintaining the facilities and equipment in good working order. The information may further include knowledge of the various resources required or desirable for providing specific services.

Based upon such information, coordinated scheduling is provided. The scheduling draws upon existing schedules of the various personnel and resources that may be needed for desired tasks and procedures, as well as the knowledge base of the times required for the various procedures and resources. Rules for adjusting schedules, prioritizing specific procedures and events, and so forth are also considered in adjusting and setting the schedules. Ultimately, coordinated schedules are provided for the personnel and resources needed for the prescribed health care procedures. The personnel and facilities, including the patients themselves, may thus be notified and their schedules produced accordingly. The schedules may be adjusted based upon similar criteria, particularly as higher priority procedures become necessary. At some point, the schedules may be fixed, particularly as scheduled procedures approach closely in time. The schedules may, of course, include ordering of necessary resources, verification of inventory of necessary resources, scheduling of special and routine maintenance and upgrades, and so forth.

The invention provides systems, methods and computer-implemented techniques for carrying out such complex functionalities.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical overview of a scheduling system in accordance with aspects of the present technique;

FIG. 2 is a somewhat more detailed diagrammatical overview of the scheduling system illustrated in FIG. 1, showing various modules and components of the system in accordance with the presently-contemplated implementation;

FIG. 3 is a diagrammatical overview of a data mining system for creation of a knowledge base for use in scheduling in accordance with certain aspects of the present technique; and

FIG. 4 is a diagrammatical overview of an exemplary performance evaluation system for generating performance parameters, such as time parameters, for use in scheduling via the system of the foregoing figures.

### DETAILED DESCRIPTION

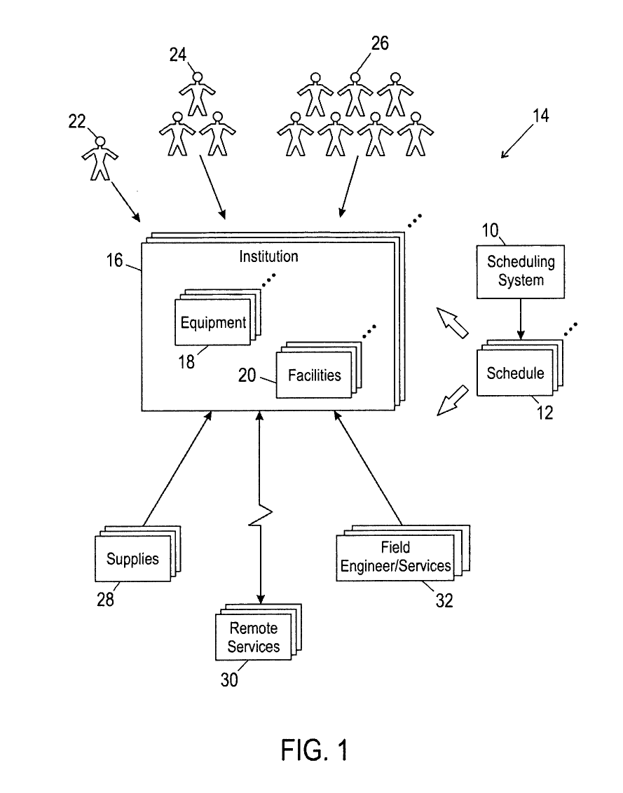

Turning now to the drawings, in referring first to FIG. 1, a scheduling system 10 is illustrated diagrammatically as it may be applied for generating schedules 12 for a health care system 14. As described in greater detail below, the scheduling system 10 will typically include one or more programmed computers and associated hardware and software. The computers will implement data mining or similar software that draws upon a range of records for evaluating times required for performing specific health care procedures and tasks. These time estimates may be based on specific characteristics, such as performance and preferences of patients, physicians, clinicians and technicians, support staff, facilities, equipment, maintenance and other service providers, field engineers, and so forth. The scheduling system computers will typically be linked to one another, if multiple computers are employed, and will either themselves store such records, or in more complex implementations, access such records for compilation of schedules and the performance information. In addition to accessing such information for evaluation of necessary resources and times, the scheduling system will receive requests for procedures and tasks, and schedule the procedures and tasks, along with the personnel and resources required, based upon the established knowledge of the performance information and the procedures, and the schedules of the personnel and components needed. Greater detail regarding the handling of schedule requests is provided below.

The scheduling system 10 produces a plurality of schedules 12 based upon such information. The schedules may pertain to any one or all of the resources required for the provision of high-quality health care, including the schedules of the patients, all personnel involved, all facilities and equipment involved, and service providers, including maintenance providers and suppliers.

The health care system 14 illustrated generally in FIG. 1 will include one or more institutions 16. Such institutions may be linked to one another, or may be completely independent. In presently contemplated contexts, the institutions may include a single office, such as a clinic, or a highly integrated institution, such as hospitals, universities, cooperating institutions, and so forth. Each institution 16 or a combination of institutions, draws upon specific equipment 18 and facilities 20. The equipment 18 will typically include complex health care systems, such as medical diagnostic imaging equipment, patient monitors, treatment equipment, and so forth. In general, such equipment may be disposable, or in the case of more complex systems, the equipment is provided at the institution for use on a relatively continuous basis as prescribed by physicians and specialists. Medical diagnostic equipment, for example, may be used throughout the day and night for generating image data that is stored and used to reconstruct and present diagnostic images for radiologists and other care providers. Due to the cost and complexity of such systems, their time-efficient use and productivity is key to the financial viability of the institution.

The facilities 20 of the institutions 16 will typically include specialized rooms, suites, departments, wards, and so forth. As will be appreciated by those skilled in the art, such facilities may be highly specialized, such as specific surgical suites, laboratories, and so forth. Of particular consequence for scheduling purposes are rooms in specific wards, emergency rooms, surgical suites, and so forth.

All of the equipment and facilities of an institution 16, as well as the other components of the health care system, of course, are ultimately intended to provide health care to a patient, indicated in FIG. 1 by reference numeral 22. As would be appreciated by those skilled in the art, the patient enters the health care system for routine monitoring of his or her state of health, as well as for addressing specific health care concerns. These concerns may result in prescribed analysis, procedures, tasks, operations, surgical interventions, and a host of other services. In general, the patient 22 will be serviced by specialists 24, such as physicians, surgeons, radiologists, and other health care professionals. In addition, a range of support staff 26, including clinicians, technicians, and the like, play a key role in the provision of health care. Such staff may include staff specialized in nursing, surgical procedures, imaging procedures, insurance processing, institutional management, and so forth. All of these contributors to the health care system will be required to be scheduled for the necessary procedures and care provided to the patient 22. While in a simplest form such schedules may include a relatively routine daily shift, other more specialized schedules will include time slots outside of this daily shift or window, as well as specific time assignments within the daily shift. More specialized contributors may have, and typically will have, more complex and adapted schedules due to the specialized procedures that require their unique skills and talents.

In addition to the equipment, facilities and human contributors, the health care system 14 draws upon a vast array of supplies 28. Many of these supplies will be reusable, while others are disposable and must be inventoried and ordered on an ongoing basis. In a typical institution, such supplies may include pharmaceuticals, bandages, clothing, bedding, gases, and any other outsourced supplies. Again, these may be inventoried and stocked by the institution where routinely needed, or may be ordered on an as-needed basis. Specialized supplies, such as components and parts of medical diagnostic equipment, imaging systems, and the like may also constitute such supplies. Due to their specialization and complexity, however, such supplies may not be stocked by the institution, but may be provided as needed and as determined by service providers.

Service providers for the institutions may include any suppliers, but in the present context, of particular interest are providers that maintain the equipment and facilities in good working order. Most full-service institutions will prefer to outsource such services to specialized providers who maintain a working knowledge of the highly-complex systems, and can offer services on an as-needed basis or by contract. Depending upon the relationship, the service provider may gain access to information regarding the operational state of the equipment remotely, as indicated generally by reference numeral 30 in FIG. 1. Remote service providers may connect to the institution and even to specific equipment, such as complex medical diagnostic imaging equipment, by any suitable means-typically via remote connectivity (e.g., a wide area network, local area network, the Internet, etc.). In certain scenarios, the institution or specific equipment may generate service requests or provide parameter data to a remote service provider who may then address such requests, schedule service, schedule maintenance, and so forth. Again, in the present context, all of such scheduling may be coordinated by the scheduling system 10.

In many instances, it will be necessary for field service providers and field engineers to address service concerns at the institution. Such field service and engineers are represented generally by reference numeral 32 in FIG. 1. As will be appreciated by those skilled in the art, such field service is typically provided by specialized technicians who visit the facility to inspect and diagnosis problems with complex equipment and systems, and repair, replace, reconfigure or otherwise service the systems. The field service technicians may provide routine service, but may also be called upon for emergency services where key equipment and systems malfunction and downtime is being experienced or anticipated. Here too, the present techniques provide for scheduling such downtime and services in coordination with patient procedures and tasks to be preformed via the equipment and facilities and by the various human contributors.

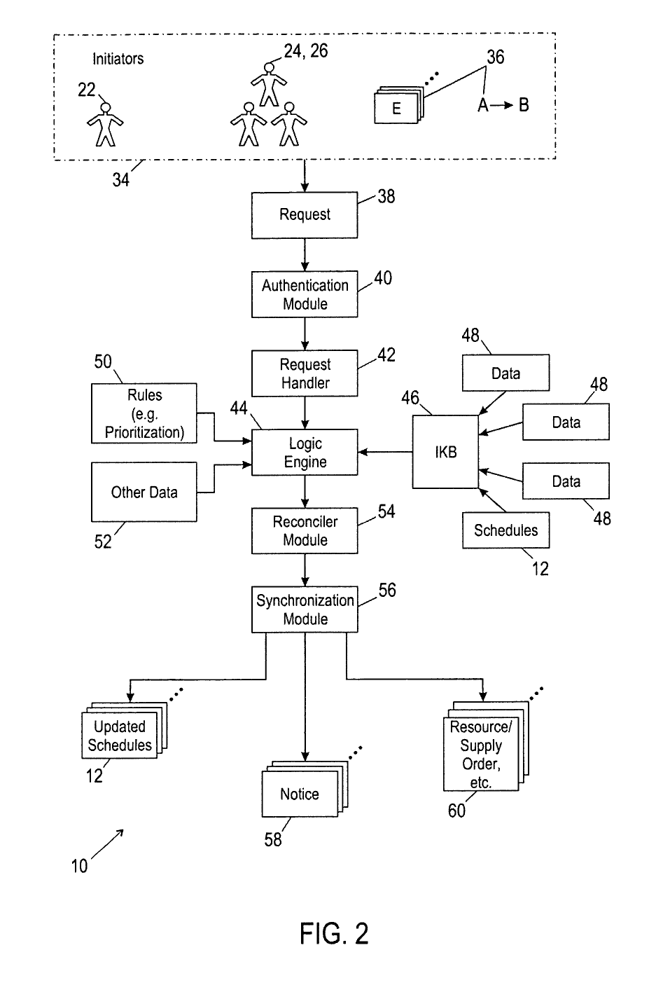

In accordance with the present technique, the highly complex scheduling of all of these resources and components is provided by the scheduling system 10, illustrated in greater detail in FIG. 2. In general, the system is based upon receipt of scheduling requests that initiate evaluation of the needs for servicing the request, the resources involved, and the time required for the various resources. As illustrated in FIG. 2, the processing performed by the system begins with various initiators 34. The initiators may include, for example, the patient 22, various physicians and professionals 24, technicians and staff 26, as well as other initiators, designated generally by reference numeral 36.

A scheduling request may be initiated manually, or via any entity within the facility or external to a specific facility or institution. Examples of health care institution entities that will initiate scheduling requests include, again, the patients, professionals, technologists, and staff. By way of example only, patients may initiate such requests via telephone, personal visits, on-line interaction, and so forth. Physicians will typically initiate scheduling requests for follow-up appointments, surgery and surgical consultation, appointments with specialists, appointments for laboratory work and examination, appointments for imaging sessions and examinations, and so forth. Similarly, imaging technologists may initiate scheduling requests based upon radiological consultations, or following appointments by referring physicians. Laboratory technologists may typically manually trigger follow-up appointments by referring physicians, and so forth. Surgeons and specialists may similarly request scheduling of surgical suites, time for surgical consultations, imaging examinations, pre-surgical lab work, and so forth.

Other providers may also be initiators of schedule requests. These may include, as discussed above, technicians and engineers that may require access to complex equipment, such as imaging systems, either remotely or on-site. Such schedules are particularly useful where the service may result in downtime or other unavailability of the equipment. Similarly, such service may be scheduled for planned maintenance, upgrades, internal monitoring and system diagnostics, and so forth. In any one of the aforementioned scenarios, support staff may manually or in a semi-automated fashion, submit a scheduling request for any one of these procedures and tasks.

Alternatively, scheduling requests may be initiated by an event. For example, if any one of a multiple of network patient monitoring systems indicates that a patient may have a diagnostic problem, the event may trigger the monitoring system to initiate a scheduling request for addressing and diagnosing the problem. Of course, the present technique does not do away with the ability to immediately address urgent concerns. However, where appropriate, such diagnostics may be performed through system 10 in response to a scheduling request.

Furthermore, initiators of scheduling requests may include systems that detect a data state change, as indicated in FIG. 2. By way of example, a radiologist may complete a read or analysis of an image sequence. Upon such completion, a scheduling request may be automatically initiated for a follow-up visit, further testing and analysis, further imaging sessions, and so forth. Other examples of such change of state information may include completion of imaging examinations, such as to schedule follow-up by a referring physician, completion of maintenance or upgrade services that end downtime or unavailability of a system, and permit scheduling of services on the system, and so forth.

A further mechanism for initiating scheduling requests may include various types of auto-initiation by systems. Such auto-initiation may occur, for example, when diagnostic software resident on a device identifies a serviceable event or condition that may be indicative of failure, impending failure or other recommended service actions. In such cases, rather than shut down or take themselves out of service, the systems may initiate a request for service that can be scheduled and upon which other affected schedules may be adjusted.

Any of the various initiators may, then, produce a request 38. The request will generally take the form of an electronic message or signal that is transmitted to a request handler 42, through the intermediary of an authentication module 40, where desired. While the request may be in the form of a message that is interpreted by a human reader, in a presently complemented embodiment, the request includes structured data that may be interpreted in an automated fashion by the request handler 42. As will be appreciated by those skilled in the art, structured data may include indications of the nature of the request, either formulated by specific classifications or categories, or interpretable to permit such classification. The structure may include specific fields—for example, tags, or any other suitable format that permits such classification. The request may be submitted automatically or, where manually submitted, may be formulated via suitable interface. Presently complemented interfaces include various web pages and so forth, which may be completed by the initiator for submission to the request handler 42.

Where provided, the authentication module 40 may include software and hardware that filter the schedule requests and verify the rights of the initiator to submit such requests. The authentication module 40 may, for example, require passwords, user identification, other user information, and may implement various permission levels and types for the initiators. The authentication module and the request handler may, moreover, record such transactions, verify contract and insurance arrangements, charge for such transactions, and so forth.

In accordance with certain aspects of the present techniques, schedules, particularly for appointments and procedures, may be based upon various characteristics either of the request/initiator or of the resources needed to be scheduled based upon the request, or both. Moreover, various types of classification may be implemented by the request handler 42 and subsequently by a logic engine 44 and other components of system 10. Such characteristics and classification may include, for example, parameters such as appointment codes or types, entities involved in providing the requested procedure, and equipment and facilities required. By way of example only, the appointment code or type may include an indication of whether the appointment is a routine visit or appointment, or whether there is a specific reason for the appointment, and inclusion of the specific reason if available or known. Characteristics of and classification by the entities involved by include an indication of professional entities, support staff, equipment, and so forth. Characteristics and classification of equipment, particularly for scheduling requests relating to servicing of such equipment, may include indications of service code, machine diagnostic data, planned maintenance actions, identification of field engineers and technicians, and so forth. Such characteristics and classification may further include, for example, a modality and type of system (e.g., an imaging modality such as MRI, CT, PET, Ultrasound, X-Ray, tomosynthesis, etc.), the manufacturer of the system, the model of the system, the age of the system, the condition of the system, and so forth. Such characteristics and classifications may be used, as described in greater detail below, to identify the resources required for fulfilling the scheduling request and performing the desired tasks and procedures.

The request handler 42 may process scheduling requests immediately as each request is received, or on various batch-type processing bases. Moreover, the request handler 42 may maintain several queues of activities to be scheduled, as well as patient availability information. Such queues may, of course, be accessed as needed by the logic engine 44 during the scheduling operation. Such queues may include, for example, a patient examination queue, a laboratory work queue, an imaging procedure queue, a therapy session queue, a surgery queue, a service activity queue, and so forth. Any logical association of schedules and resources may form the bases for such queues.

The request handler 42 will typically include one or more programmed computers which can be addressed by the initiators 34. The computers receive the request in the form of electronic messages. The request handler classifies or otherwise parses the request and submits them to a logic engine 44. In a typical application, the request handler 42 may include communications hardware and software, such as a router and a server that may interact with the initiators, such as to acknowledge receipt of a scheduling request. The logic engine 44 may reside on the same program computer as the request handler 42, or on a connected system. The logic engine 44 will essentially consist of software for drawing upon resource and schedule data, such as performance knowledge that may be compiled in an integrated knowledge base (IKB) 46, as well as upon specific scheduling rules 50 and other data 52.

The request handler 42 and logic engine 44 may implement an event monitor that passes the scheduling request on for processing as it is received, or processes requests on a batch-type bases. Certain requests may, of course, be handled by specific priorities set and implemented by the request handler 42 or logic engine 44. For example, an administrator may program these components to handle certain types of scheduling requests on an expedited basis. Where such scheduling is necessary, however, all scheduling and coordinated scheduling may not necessarily be optimized. Accordingly, in certain contexts, optimal scheduling may be best provided by handling requests on batch-time bases. Where batch scheduling is provided, requests may be held in a queue for a specific period of time or until a specific number of requests are received as specified by the administrator. Such batch processing, again, may permit optimization through maximization of patients throughput, minimization of costs, maximum productivity of equipment and facilities, as so forth.

Depending upon the types of appointments and procedures to be scheduled, these may be scheduled in accordance with different lead times. For example, outpatient appointments may be scheduled weeks in advance while reserving, based upon historic data, a percentage of time slots for emergency procedures and appointments. In-patient procedures and exams, on the other hand, may be scheduled with shorter delays as the patients are generally more readily available in the institution or facility for such procedures. More will be said below regarding the rules and prioritization of scheduling.

Once the legitimacy of the origins of the scheduling requests has been verified, they are passed from the request handler 42 to the logic engine 44. The logic engine 44 schedules resources based upon all incoming scheduling requests utilizing several sets of resources, logic rules, decision algorithms, and so forth. As noted above, the logic engine 44 may draw upon an IKB 46, or may directly access information without referring specifically to a pre-established knowledge base. Based upon the rules 50, and upon any other data 52 considered by the logic engine 44, the logic engine identifies the necessary resources, their schedules, and determines when and for how long such resources must be scheduled to accommodate the requests. The logic engine 44 may perform such scheduling based upon any suitable type and structure of processing, such as neural networks, linear programming, or other processing techniques. The processing performed by the logic engine 44 based upon the data input and the rules will, of course, be adapted for the specific institution, the procedures involved, the resources required, and so forth. Such programming is considered for the present purposes to be well within the ambit of capable programmers and does not require undo experimentation.

As described in greater detail below, the logic engine 44 may draw upon an IKB 46 which may be considered to include one or more knowledge bases, relational databases or any other data structure or associated data which compiles known characteristics and performance information, and, where desired, schedule data as well. In actual implementation, the IKB 46 may be stored in one or multiple locations, and accessed by the logic engine 44 locally or remotely. In certain implementations, the information accessed to create the IKB, and the information included in the IKB, may be more or less complete, but will advantageously include information that complements the schedule information for determining what resources are required, and characteristics and performance of the resources useful in projecting times needed for scheduling.

In the embodiment illustrated in FIG. 2, the IKB 46 incorporates and is based upon various types of data indicated generally by reference numeral 48 and described in greater detail below. The data 48 may be used to identify the performance of various components of the health care system, including human resources, facilities and equipment. The performance indications will provide a guide for times required for the various resources needed for the scheduled tasks and procedures. In conjunction with the schedules of the various entities (personnel, equipment, facilities, supplies, service providers, etc.), then, the logic engine 44 may implement the rules for scheduling the resources.

It should be noted that, as used herein, the terms “performance” and “performance data” are intended to relate to a wide variety of information. As discussed herein, the information may be indicative of durations for procedures and durations of lead times, typically determined based upon historical data for the procedures, expert estimates, preferences provided by physicians and others, and so forth. However, terms also include such factors as skills of persons involved in the procedures, training levels, and so forth. Similarly, the performance information may account for known abilities or limitations of facilities and equipment, such as imaging protocols, software versions, speeds of equipment, and so forth.

As described in greater detail below, the data accessed and analyzed for use by the logic engine 44, and that may be included in the IKB 46, may include any data related to performance of any one of the components of the health care system. For example, historic records indicative of appointment times, procedure durations, and so forth may be accessed for any one or all of the components and analyzed to determine an appropriate time for the scheduled procedure or task. Appointment times for each of the activities may be calculated based upon a combination of factors, moreover. Such factors may include, for example, estimated time for a particular type of appointment independent of specific professionals involved, or independent of specific equipment involved. Likewise, an average appointment time could be personalized for each individual contributor or interaction of specific contributors. Moreover, appointment times may be trended according to subgroups of individual contributors, such as by reference to the actual person involved, the person's experience level, the training level, and so forth. All persons involved in the specific scheduled procedure or task may thus be evaluated and such data taken into account in the IKB. In a present implementation, once analyzed as described below, the information with regards to such persons and equipment may be stored in the IKB for reference by the logic engine in scheduling the times for the resources and the durations for procedures and tasks.

The logic engine 44, through the IKB 46 or directly, will also access schedules 12 for each of the scheduled components or contributors. In a presently complemented embodiment, the schedules may include schedules for patients, physicians, equipment, facilities, technologists, remote service personnel, field engineers, and so forth. For example, physicians may contribute to the various procedures and tasks, and these physicians may include primary care physicians, specialists, radiologists, surgeons, and so forth. Equipment schedules may include schedules for imaging equipment, therapy equipment, laboratories, and so forth. Among the facilities that may be scheduled, may be included operating rooms, hospital rooms, emergency units, imaging suites, surgical suites, and so forth. Technologists and clinicians may include specialized imaging technicians, lab technicians, specialized nursing staff, and so forth. Versions of the schedules will be modified by the logic engine as described below. These modifications may change existing schedules or simply add additional allotted assignments to the schedules.

Logic engine 44 also calls upon certain rules 50 for coordinating the schedules in accordance with the requested scheduling. A wide range of rules may be implemented, typically assigning priorities to specific procedures, persons, equipment, resources, supplies, and so forth. The rules may be programmed by the administrator and may be adapted depending upon changes in available resources, priorities, and so forth. In a presently complemented embodiment, the rules may be structured to accomplish optimization of scheduling of the various resources, such as to maximize patient throughput, to minimize personnel necessary for any one shift or time period, to avoid excessive personnel available for any shift or time period, or to minimize equipment necessary for particular procedures or time periods, maximizing the utilization and productivity of the equipment.

Specific schedules for specific individual contributors and persons may also be accommodated by the rules. For example, a primary physician or first choice physician may be unavailable, and patient activity may be highly prioritized. In such situations, the system may determine an alternate physician based upon patient-defined preferences and if available, schedule the physician by such preferences or by referral. By way of further example, the system may be implemented to accommodate physician schedules on a priority basis over the schedules of technologists, field engineers and equipment, for example. If no mutually accepted time is found, activities may be rescheduled, including existing scheduled activities to accommodate the physician availability. Moreover, if, for some reason, the patient procedure must be rescheduled on the actual day for which the procedure is scheduled, such as due to equipment downtime, or technician or physician unavailability, the procedure may be rescheduled as close as possible to the original time, shifting other appointments if necessary to minimize the average or total time shift for all patients. Similarly, field engineer scheduling rules may be implemented that minimize field engineer travel time or travel distance while maximizing the speed of resolution of high priority service activities.

Rules affecting specific equipment and facilities may also be implemented. For example, for operating and surgical suites, lead time may be reduced significantly for dynamic scheduling, allowing for appointments to be changed with little or no notice for maximum flexibility. The same may be true for emergency equipment or equipment that can be displaced or otherwise utilized for emergency services. For clinics, lead time of a longer duration, such as one week for dynamic scheduling may be implemented, with appointments being changed up to one week in advance as long as proper notifications are possible.

The rules may also limit or end the dynamic nature of scheduling, essentially fixing schedules within a certain time period prior to a scheduled event or procedure. Depending upon the procedure, such fixing of schedules may occur within days, hours, or even minutes of the scheduled time slots.

Among the features envisioned for the scheduling rules, are priority levels for various times of activities and procedures. For example, for technical service or maintenance activities, five such levels may be envisioned, including a highest level for emergency maintenance and repair that may override some or all scheduled patient activities. A lower level of urgent service activity may then fall below the highest level, and may override all but the highest priority of patient examinations. A non-urgent service activity level, then, may schedule service within a specific time period, such as one day, and reschedule only lower priority service activities in a field engineer schedule if no acceptable time is available, or as a last resort, reschedule patient procedures if a field engineer is not available. An even lower level of service priority may be defined as a predictive service activity level wherein services are scheduled before an end date to avoid potential equipment downtime. Finally, a lowest priority level may be assigned for planned maintenance activities, which may be scheduled in extra time before an end date, if possible, unless a field engineer is on site for other maintenance at an earlier date.

Similarly, a hierarchy or a priority scheme may be implemented for patient examination activities. By way of example, a highest priority may be set for critical patient needs that may override all other scheduled patient activities and service activities. A lower level of priority may be assigned for urgent patient needs which may override all but the highest priority examination. A still further level of priority may be assigned for reactive appointments, which may be scheduled within a specific time period, such as three days, and on the basis of which lower priority activities may be rescheduled if no acceptable time is available for the reactive appointment. A further lower level, which may be designated for follow-up appointments, may be implemented for scheduling appointments before an end date to avoid potential patient issues, and to provide adequate follow-up. Finally, a still lower level may be provided for routine check-up appointments. Such appointments may be scheduled in open time slots before an end date, if possible. Such appointments may also be displaced by the logic engine for any higher level priority patient-related activity, or service activities of a specific priority level or higher, as long as dynamic scheduling object rules are maintained.

In addition to the performance data contained in the IKB, the schedules and the rules, the logic engine 44 may draw upon other data as indicated at reference numeral 52 in FIG. 2. Such other data may include, for example, a wide range of information pertaining to the state of equipment, the preferences of patients, known interrelationships or relationships between physicians and patients, field engineer locations, locations and quantities in inventory, and so forth. The other data may permit evaluation, for example, of vacation periods in which one or more necessary contributors are unavailable, or may be used to estimate travel time of contributors, field engineers, or even delivery times of parts and supplies required or preferred for the activities.

The logic engine thus assigns time slots for the activities and for the contributors, equipment, facilities and supplies needed for the activities. A reconciler module 54 identifies any conflicts that may exist, and may resolve such conflicts with or without human intervention. In a typical application, the reconciler module 54 will include software designed to operate on the schedules or adjustments to the schedules determined by the logic engine 44. The reconciler module 54 may include its own rules, or may draw upon rules 50, such as for resolving conflicts based upon priority levels. The reconciler module may access additional schedules, such as for alternative resources to resolve such conflicts. In the presently complemented implementations, the reconciliation is at least partially based upon human intervention, or on a first come-first served basis following times of receipt of the scheduling requests.

When all scheduling issues have been reconciled, the process advances to a synchronization module 56 where the various schedules are updated. The synchronization module 56 may thus altar the schedules as indicated in FIG. 2, adding or adjusting time slots that may be represented in user-viewable presentations in a conventional manner. The process also preferably generates notices 58 for apprising the individual contributors and managers of facilities and equipment of the schedules. These notices may be sent in any suitable manner, just as electronically. In certain cases, the notices will be output for staff personnel who will contact patients, physicians, and other staff to apprise them of new scheduling of appointments and procedures, as well as changes in the scheduling. Finally, the process may output orders or commands for specific resources, supplies, field replaceable units, and so forth as indicated at reference numeral 16 in FIG. 2.

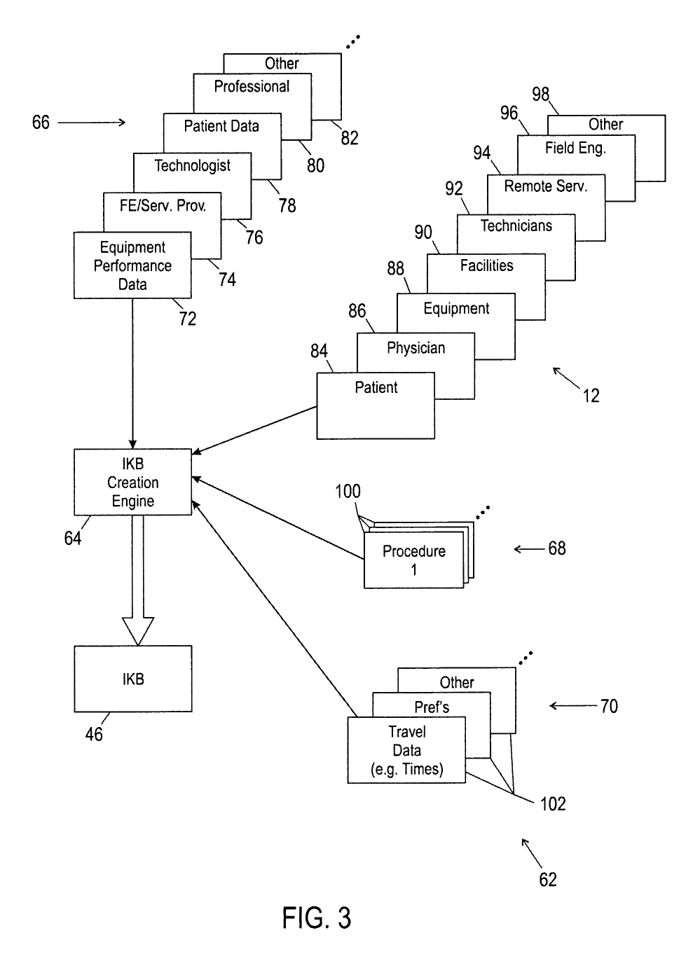

As noted above, the various information accessed by the logic engine 44 may be stored in an IKB 46, or may be accessed directly. Storage of the information in an IKB facilitates scheduling and may speed scheduling by maintaining performance measurements and times, as far as other information readily available for the logic engine. FIG. 3 represents an exemplary overview of creation of the IKB in accordance with the present implementation.

The IKB creation system 62 includes an IKB creation engine 64 which will generally include software and hardware designed to access a range of records and data and analyze the data to identify trends, statistical correlations, statistical parameters, and so forth. The IKB creation engine 64, moreover, may operate on historic records, but may also update the information on a periodic basis as new or supplemental information becomes available, particularly for changing performance of individuals, equipment, and facilities, and as new individuals, equipment and facilities become available. The IKB creation engine 64, in particular, may access information that may be categorized as performance data 66, as well as the various schedules 12 of the contributors and resources. Moreover, the system may access procedure data 68 and other data 70 as described below.

In general, the performance data 66 may include various records that indicate past procedures of a similar type by particular characteristics or classification in which particular individuals, equipment, facilities or supplies were involved. Where available, such information will provide an indication of the times required for the specific tasks of the individuals, equipment, facilities and supplies.

More specifically, the information may be available from equipment performance data 72, such as activity logs kept on or for specific components of equipment. A field engineer and service provider data 74 may also be referred to, such as from service records. Technologist information 76 may be available, such as by reference to records of activities in which specific technologists or clinicians were involved. Patient data 78 may also be accessed, while maintaining confidentiality requirements for individual patients, to indicate patient preferences, specific patient issues, and so forth, which may influence the time required for performance of individual tasks, or which may influence the resources or equipment necessary for performing tasks for specific patients. Professional records and similar data may be available, such as to indicate preferences and durations of procedures preformed by individual professionals, particularly physicians, surgeons, radiologists, and so forth. Reference numeral 82 indicates other information that may be available and used for performance evaluation. As described in greater detail with reference to FIG. 3, the performance information is essentially used to identify time periods which may statistically be relevant, or which may be preferred for individual contributors, equipment, facilities and supplies.

The IKB creation engine 64 may also access schedules for any or all of the individuals, equipment, facilities and supplies required for scheduling the desired procedures and tasks. The individual schedules will typically include a patient schedule 84, physician schedules 86, equipment schedules 88, facilities schedules 90, technician schedules 92, remote service provider schedules 94, field engineer and technician schedules 96, and any other relevant schedules, indicated generally by reference numeral 98. For rapid access and processing, some or all of these schedules may be stored in the IKB itself, or the individual schedules may be accessed on an as-needed basis by the logic engine 44.

The procedure data 68 may also be included in the IKB, and considered by the IKB creation engine 64 for updating the IKB. Such procedure data may include a range of procedure records, indicated generally by reference numeral 100, that may provide guidance as to the individual resources needed or desired for individual procedures. These guidelines may be quite detailed, where desired. For example, specific types of equipment and specific procedures, such as imaging protocols, may be indicated. The data may also include supplies that may be required, alternative or emergency equipment or personnel that may need to be on hand, and so forth. This procedure data is referred to for evaluating the particular schedules that will be affected in scheduling the requested procedure.

Finally, various other data may be considered by the IKB creation engine 64 as indicated generally at reference numeral 70. Such data, indicated generally by reference numeral 102 in FIG. 3 may be accessed from any suitable resource, and may include such information as travel data (e.g., used to estimate travel times of individual contributors, field engineers and the like), preferences of the various individual contributors, patients, and so forth. Here again, this information may be used both to estimate times required for specific procedures, lead times necessary before scheduling certain procedures, and the various resources, preferred or required, to be scheduled.

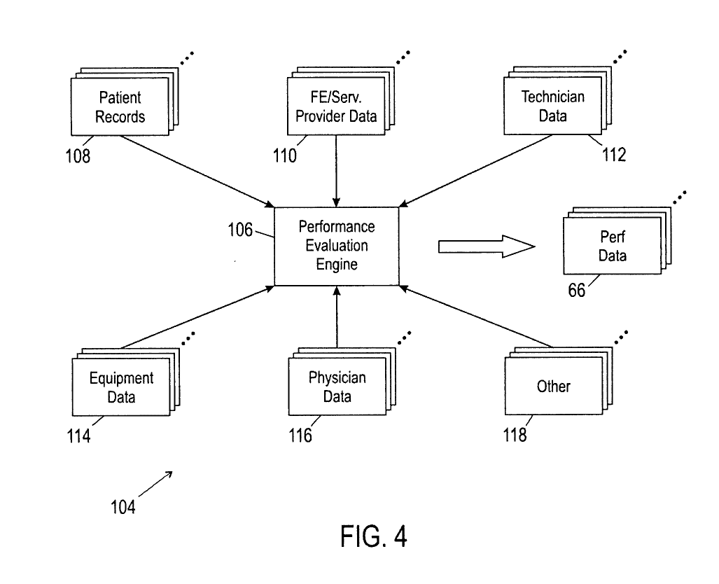

As noted above, the present technique conveniently and advantageously makes use of estimations of both durations of procedures and tasks by specific characteristics or classification, and lead times that may be required for specific resources. This information may be evaluated either by the IKB creation engine 64 represented in FIG. 3, or by a separate data processing module. FIG. 4 represents a performance evaluation system 104 that is based upon a performance evaluation engine 106. The performance evaluation engine 106 will typically include software and hardware for accessing the type of performance information discussed above, and for drawing statistical relationships between and among the data to evaluate lead times and durations required by reference to specific characteristics or classifications. Again, these characteristics and classifications may include, for example, individual contributors, specific pieces of equipment, specific facilities, specific supplies, and so forth. As also noted above, the performance evaluation engine 106 need not freeze this information in time. Rather, upon establishment of the performance parameters, the information may be stored for use in an IKB or, more generally, in the scheduling performed by the logic engine. Over time, then, as new resources become available or as performance changes, the performance parameters may be updated and stored.

As indicated generally in FIG. 4, the performance evaluation engine 106 may draw upon a range of resource information, including patient records 108. The patient records, which again may be processed to prevent unwanted identification of individual patients, may be provided in the form of an electronic patient record. The record may be evaluated for patient preferences, specific patient challenges (e.g., sensibilities, handicaps, etc.) that require additional time or resources, and so forth. Similarly, data relating to individual field engineers and service providers may be provided as indicated at reference numeral 110. This information may include not only the time required for specific types of tasks and category of tasks, but any lead times which should be respected in ordering service, parts, and so forth. Similarly, technician data 112 may be accessed, particularly information relating to individual technicians and clinicians, times required for performing individual tasks, skill levels, experience levels, training levels, and so forth.

Similar equipment data 114 may be provided. This equipment data may not only include types of specific equipment, but manufacturers of equipment, capabilities of equipment, service records of the equipment, as well as tasks able to be performed on the equipment. For example, specific medical diagnostic imaging equipment may require specialized protocols while performing imaging sequences. The performance engine may evaluate the duration of such imaging sequences based upon the individual sequence type, the types of images to be obtained, and known issues or delays involved in obtaining the images, preparing patients for imaging sequences, and so forth.

Similar physician information 116 may be considered, particularly information relating to specific procedures performed by specific physicians, their preferences, lead times and delays in preparing patients, teams, equipment, supplies, and so forth.

Finally, as represented generally by reference numeral 118, the performance evaluation engine 106 may consider other data. Such data may include, for example, inventory information, lead time for ordering or receiving individual supplies, delays in preparing facilities and rooms, delays in cleaning or follow-up in facilities and rooms, and so forth.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for scheduling health care resources comprising:
receiving a request for scheduling a desired health care procedure;
identifying health care resources for performing the desired procedure;
identifying a characteristic of at least one of health care resources required for performing the desired procedure and a characteristic of the request;
accessing resource data for the resources in accordance with the identified characteristic;
accessing schedules for each of the required resources; and
creating, deleting, modifying or recommending the schedules based upon the resource data and the desired procedure.

2. The method of claim 1, wherein the characteristic includes a particular resource or protocol required for performing the desired procedure.

3. The method of claim 1, wherein the characteristic includes a patient preference.

4. The method of claim 1, wherein the characteristic includes a priority level.

5. The method of claim 1, wherein the desired procedure includes a surgical procedure to be performed on a patient.

6. The method of claim 1, wherein the desired procedure includes a medical diagnostic imaging procedure.

7. The method of claim 1, wherein the desired procedure includes technical servicing of a medical diagnostic system used for patient health evaluation.

8. The method of claim 1, wherein the schedules created, deleted, modified or recommended include at least a schedule for a laboratory procedure.

9. The method of claim 1, wherein the schedules created, deleted, modified or recommended include at least a schedule for a physician appointment.

10. The method of claim 1, wherein the resource data is stored in an integrated knowledge base along with performance information for the at least one resource.

11. The method of claim 10, wherein the integrated knowledge base includes data representative of time durations required for resources required for a plurality of health care procedures.

12. The method of claim 1, further comprising prioritizing the request with respect to other received requests based at least in part upon the characteristic.

13. A method for scheduling health care resources comprising:
receiving a plurality of requests for scheduling desired health care procedures;
identifying health care resources required to perform the desired procedures;
identifying a characteristic of at least one of health care resources required for performing the desired procedure and a characteristic of the request;
accessing resource data for the resources in accordance with the identified characteristic;
accessing schedules for the required resources;
prioritizing the requests based upon at least one of a characteristic of the request and a characteristic of the resources; and
creating, deleting, modifying or recommending the schedules based upon the resource data and the desired procedures.

14. The method of claim 13, wherein the resource data is stored in an integrated knowledge base along with performance information for the at least one resource.

15. A method for scheduling health care resources comprising:
receiving a plurality of requests for scheduling a desired health care procedures from a plurality of different request initiators;
identifying health care resources required to perform the desired procedures;
identifying a characteristic of at least one of health care resources required for performing the desired procedure and a characteristic of the request;
accessing resource data for the resources in accordance with the identified characteristic;
prioritizing the requests based upon at least one of a characteristic of the request and a characteristic of the resources;
accessing schedules for the required resources; and
modifying the schedules based upon the resource data and the desired procedures.

16. The method of claim 15, wherein the resource data is stored in an integrated knowledge base along with performance information for the at least one resource.

17. The method of claim 15, wherein the initiators include a patient and a care provider.

18. The method of claim 15, wherein the initiators include a technical service provider for medical diagnostic equipment.

19. The method of claim 15, wherein at least one of the initiators is based upon a change of state of a health care parameter.

20. The method of claim 19, wherein the change of state includes completion of a health care procedure.

21. The method of claim 19, wherein the characteristics include urgency levels for the procedures.

22. The method of claim 19, wherein patient medical procedures are prioritized over equipment service procedures.

23. The method of claim 19, comprising fixing at least one schedule based upon proximity of a scheduled procedure from a time or receipt of a request.

24. A computer program for scheduling health care resources comprising:
at least one machine readable medium; and
computer code stored on the at least one machine readable medium including instructions for receiving a request for scheduling a desired health care procedure, identifying health care resources for performing the desired procedure, identifying a characteristic of at least one of health care resources required for performing the desired procedure and a characteristic of the request, accessing resource data for the resources in accordance with the identified characteristic accessing schedules for each of the required resources, and creating, deleting, modifying or recommending the schedules based upon the resource data and the desired procedure.
